(19) United States
(12) Patent Application Publication
(10) Pub. No.: US 2021/0122985 A1
(43) Pub. Date: Apr. 29, 2021

(54) UPGRADING AND EXTRACTION OF HEAVY OIL BY SUPERCRITICAL WATER

(71) Applicant: Saudi Arabian Oil Company, Dhahran (SA)

(72) Inventors: Ki-Hyouk Choi, Dhahran (SA); Bader M. Alotaibi, Dhahran (SA); Bandar K. Alotaibi, Dhahran (SA)

(21) Appl. No.: 16/665,361

(22) Filed: Oct. 28, 2019

(51) Int. Cl. C10G 33/06; C10G 67/14; B01D 17/02; B01D 17/04; C02F 1/40; C02F 1/38

(52) U.S. Cl. CPC C10G 33/06; C02F 2001/007; B01D 17/0214; B01D 17/044; B01D 17/0217; C02F 1/40; C02F 1/385; C10G 2300/205; C10G 2300/206; C10G 2300/202; C10G 2300/301; C10G 2300/302; C10G 2300/308; C10G 2300/208; C10G 2300/805; C10G 2300/4012; C10G 2300/4006; C10G 67/14

(57) ABSTRACT

A method of producing a product oil stream comprising the steps of mixing the liquid product in the product mixing tank for a mixing residence time to produce a mixed liquid product, maintaining the mixed liquid product in the product separation tank for a separation residence time, separating upgraded hydrocarbons from the mixed liquid product in the product separation tank, where the separation residence time allows the upgraded hydrocarbons to separate from and float on top of a water layer in an inlet section of the product separation tank, operating the product separation tank such that the upgraded hydrocarbons flow over a weir, the weir configured to separate the inlet section from an oil collection section, withdrawing the product oil stream from the oil collection section, where the product oil stream comprises upgraded hydrocarbons, and withdrawing a spent water from the inlet section of the product separation tank.

### TECHNICAL FIELD

Disclosed are methods for upgrading hydrocarbons. Specifically, disclosed are methods and systems for upgrading hydrocarbons to reduce a heavy end fraction.

### BACKGROUND

In general, petroleum-based oil is not miscible in liquid water because of repulsive interaction between petroleum-based oil and water. However, the presence of polar compounds in the petroleum-based oil can enable the formation of a stable emulsion which is in colloidal state. Polar compounds in the petroleum-based oil have oxygen and nitrogen which can render polarity to the molecules. Such polar compounds are concentrated in the resin and asphaltene fractions of petroleum-based oil. Resin and asphaltene are concentrated in the high boiling temperature ranges. Resin and asphaltene fractions are main constituents present in the interfacial film surrounding the stabilized droplets of oil in the oil-in-water emulsion.

To destabilize the emulsion and separate the petroleum-based oil and water, the stabilized droplets of oil in the oil-in water emulsion must be destabilized. One way to destabilize the stabilized emulsion is to increase the temperature to greater than about 80 deg C. Most commonly, a demulsifier or demulsifying agent is added to the stabilized emulsion. A demulsifier is a type of surfactant that can destabilize the interfacial film and then facilitates coalescence of droplets. The demulsifier can also accelerate the time to separation of the petroleum-based oil and water.

Additionally, the heavier fractions, such as the resin and asphaltene fractions, can be difficult to be processed in conventional refining processes. In hydrocracking units, the heavier fractions can deactivate the catalyst after shorn run times. In delayed coking processes, the heavier fractions can generate significant amounts of low value coke reducing the efficiency and yield of the delayed coking process.

### SUMMARY

Disclosed are methods for upgrading hydrocarbons. Specifically, disclosed are methods and systems for upgrading hydrocarbons to reduce a heavy end fraction.

In a first aspect, a method of producing a product oil stream is provided. The method includes the steps of introducing a liquid product to a product mixing tank, where the product mixing tank includes an internal mixing device, where the pressure in the product mixing tank is greater than the steam pressure of water at the temperature of the liquid product, and mixing the liquid product in the product mixing tank for a mixing residence time to produce a mixed liquid product, where the mixing residence time is between 5 minutes and 120 minutes. The method further includes the steps of introducing the mixed liquid product to a product separation tank, where the product separation tank includes a weir, where the pressure in the product mixing tank is greater than the steam pressure of water at the temperature of the liquid product, maintaining the mixed liquid product in the product separation tank for a separation residence time, where the separation residence time is at least 10 minutes, separating upgraded hydrocarbons from the mixed liquid product in the product separation tank, here the separation of upgraded hydrocarbons from the mixed liquid product occurs due to gravity separation where the separation residence time allows the upgraded hydrocarbons to separate from and float on top of a water layer in an inlet section of the product separation tank, operating the product separation tank such that the upgraded hydrocarbons flow over a weir, the weir configured to separate the inlet section from an oil collection section, where the upgraded hydrocarbons collect in the oil collection section, withdrawing the product oil stream from the oil collection section, where the product oil stream includes upgraded hydrocarbons, and withdrawing a spent water from the inlet section of the product separation tank, where the spent water includes water and a heavy end fraction.

In certain aspects, the method further includes the step of withdrawing a gas product from the product separation tank. In certain aspects, the method further includes the steps of introducing the spent water to a water treatment unit, the water treatment unit configured to separate the heavy end fraction from the water, and separating the heavy end fraction from the water in the water treatment unit to produce a recycled water and a sludge, where the recycled water stream includes clean water, where the sludge includes the heavy end fraction. In certain aspects, the method further includes the step of introducing the recycle water to a water storage tank. In certain aspects, the method further includes the steps of introducing a feed oil to a feed oil pump, where the feed oil includes a single phase oil processed in a deasalter, where the feed oil includes a heavy end fraction, where the amount of the heavy end fraction is at least 2 wt %, increasing a pressure of the feed oil in the feed oil pump to produce a pressurized feed oil, where the pressure of the pressurized feed is greater than the critical pressure of water, introducing the pressurized feed oil to a feed oil heater, increasing a temperature of the pressurized feed oil in the feed oil heater to produce a hot feed oil, where a temperature of the hot feed oil is between ambient temperature and 250 deg C., and introducing the hot feed oil to a mixer. The method further includes the steps of introducing a feed water stream to a feed water pump, where the feed water stream includes a demineralized water, increasing a pressure of the feed water stream in the feed water pump to produce a pressurized feed water, where the pressure of pressurized feed water is greater than the critical pressure of water, introducing the pressurized feed water to a feed water heater, and increasing a temperature of the pressurized feed water in the feed water heater to produce a supercritical water stream, where the temperature of the supercritical water stream is greater than the critical temperature of water. The method further includes the steps of introducing the supercritical water stream to the mixer, mixing the hot feed oil and the supercritical water stream in the mixer to produce a mixed feed stream, introducing the mixed feed stream to a reactor, and reacting the mixed feed stream in the reactor to produce a reactor effluent, where mixed feed stream undergoes conversion reactions, where the reactor effluent includes upgraded hydrocarbons, and a water phase. The method further includes the steps of introducing the reactor effluent to a cooling device, reducing a temperature of the reactor effluent in the cooling device to produce a cooled effluent, where the temperature of the cooled effluent is between 50 deg C. and 350 deg C., introducing the cooled effluent to a depressurizing device, reducing a pressure in the depressurizing device to produce a product effluent, where the pressure of the product effluent is greater than the steam pressure of water at the temperature of cooled effluent, introducing the product effluent to a gas-liquid separator, and separating the product effluent in the gas-liquid separator to produce a vapor product and the liquid product. In certain aspects, the method further includes the steps of introducing a separated water stream to the product mixing tank, where the volumetric flow rate of separated water stream is operable to maintain a volumetric ratio of hydrocarbon to water in product mixing tank of less than 0.8, and mixing the separated water stream with the liquid product. In certain aspects, the method further includes the steps of introducing the mixed liquid product to a continuous centrifuge unit, centrifuging the mixed liquid product in the continuous centrifuge unit, and withdrawing a centrifuge outlet stream. In certain aspects, the product separation tank is in the absence of a demulsifying agent.

In a second aspect, a system for producing a product oil stream is provided. The system includes a product mixing tank, the product mixing tank configured to mix a liquid product for a mixing residence time to produce a mixed liquid product, where the mixing residence time is between 5 minutes and 120 minutes, where the product mixing tank includes an internal mixing device, where the pressure in the product mixing tank is greater than the steam pressure of water at the temperature of the liquid product, where the liquid product includes upgraded hydrocarbons and a water phase, and a product separation tank fluidly connected to the product mixing tank, where the pressure in the product mixing tank is greater than the steam pressure of water at the temperature of the liquid product, where the product separation tank is configured to separate upgraded hydrocarbons from the mixed liquid product for a separation residence time, where the separation residence time is at least 10 minutes, where the separation of upgraded hydrocarbons from the mixed liquid product occurs due to gravity separation, where the separation residence time allows the upgraded hydrocarbons to separate from and float on top of a water layer in an inlet section of the product separation tank. The product separation tank includes an inlet section configured to receive the mixed liquid product, where the gravity separation occurs in the inlet section, an oil collection section configured to collect the upgraded hydrocarbons, a weir physically separates the inlet section and the oil collection section, where the upgraded hydrocarbons flow over the weir from the inlet section to the oil collection section, a product outlet fluidly connected to the oil collection section, where a product oil stream flows from the oil collection section through the product outlet, where the product oil stream includes upgraded hydrocarbons.

In certain aspects, the system further includes a water outlet fluidly connected to the inlet section, where a spent water flows from the inlet section through the water outlet, where the spent water includes a water phase, where the water phase includes heavy end fraction dispersed in water. In certain aspects, the system further includes a water treatment unit, the water treatment unit configured to separate the heavy end fraction from the water in the spent water, where the heavy end fraction exists the water treatment unit as a sludge, where the water exits the water treatment unit as a recycled water. In certain aspects, the system further includes a water storage tank, the water storage tank configured to collect the recycle water. In certain aspects, the system further includes a feed oil pump configured to increase a pressure of a feed oil to produce a pressurized feed oil, where the feed oil includes a single phase oil processed in a deasalter, where the feed oil includes a heavy end fraction, where the amount of the heavy end fraction is at least 2 wt %, where the pressure of the pressurized feed is greater than the critical pressure of water, and a feed oil heater fluidly connected to the feed oil pump, the feed oil heater configured to increase a temperature of the pressurized feed oil in the feed oil heater to produce a hot feed oil, where a temperature of the hot feed oil is between ambient temperature and 250 deg C. The system further includes a feed water pump configured to increase a pressure of the feed water stream to produce a pressurized feed water, where the feed water stream includes a demineralized water, where the pressure of pressurized feed water is greater than the critical pressure of water, a feed water heater fluidly connected to the feed water pump, the feed water heater configured to increase a temperature of the pressurized feed water to produce a supercritical water stream, where the temperature of the supercritical water stream is greater than the critical temperature of water, and a mixer fluidly connected to the feed oil heater and the feed water heater, the mixer configured to mix the hot feed oil and the supercritical water stream to produce a mixed feed stream. The system further includes a reactor fluidly connected to the mixer, where the reactor is configured to react the mixed feed stream in the reactor to produce a reactor effluent, where mixed feed stream undergoes conversion reactions, where the reactor effluent includes upgraded hydrocarbons and a water phase, a cooling device fluidly connected to the reactor, the cooling device configured to reduce a temperature of the reactor effluent in the cooling device to produce a cooled effluent, where the temperature of the cooled effluent is between 50 deg C. and 350 deg C., a depressurizing device fluidly connected to the cooling device, the depressurizing device configured to reduce a pressure of the cooled effluent to produce a product effluent, where the pressure of the product effluent is greater than the steam pressure of water at the temperature of cooled effluent, and a gas-liquid separator fluidly connected to the depressurizing device, the gas-liquid separator configured to separate the product effluent to produce a vapor product and the liquid product. In certain aspects, the system further includes a continuous centrifuge unit fluidly connected to the product mixing tank, the continuous centrifuge configured to centrifuge the mixed liquid product to produce a centrifuge outlet.

### BRIEF DESCRIPTION OF THE DRAWINGS

These and other features, aspects, and advantages of the scope will become better understood with regard to the following descriptions, claims, and accompanying drawings. It is to be noted, however, that the drawings illustrate only several embodiments and are therefore not to be considered limiting of the scope as it can admit to other equally effective embodiments.

FIG. 1 provides a process diagram of an embodiment of the upgrading process.

FIG. 2 provides a process diagram of an embodiment of the upgrading process.

FIG. 3 provides a process diagram of an embodiment of the upgrading process.

FIG. 4 provides a process diagram of an embodiment of the upgrading process.

FIG. 5 provides a process diagram of an embodiment of the upgrading process.

FIG. 6 provides a process diagram of an embodiment of the upgrading process.

In the accompanying Figures, similar components or features, or both, may have a similar reference label.

### DETAILED DESCRIPTION

While the scope of the apparatus and method will be described with several embodiments, it is understood that one of ordinary skill in the relevant art will appreciate that many examples, variations and alterations to the apparatus and methods described here are within the scope and spirit of the embodiments.

Accordingly, the embodiments described are set forth without any loss of generality, and without imposing limitations, on the embodiments. Those of skill in the art understand that the scope includes all possible combinations and uses of particular features described in the specification.

The processes and systems described are directed to processes to upgrade crude oils. The processes and systems described here may reduce the total liquid yield of the product oil stream but improves the overall quality of the product oil stream.

Advantageously, the processes and systems described here use the supercritical water to extract a heavy end fraction of the crude oil, improving the overall quality of the product oil stream and reducing the complexity of the processes and systems. Advantageously, because full separation of the heavy end fraction from the water is not achieved in the product separation tank, the heavy end fraction is easily separated from the upgraded hydrocarbons. The result is an upgraded oil product that contains less of the heavy end fraction and therefore is of better quality. Advantageously, separating the heavy end fraction is a simple process in a waste water treatment unit. Advantageously, the processes and systems minimize the loss of upgraded hydrocarbons as being rejected in the water with the heavy end fraction.

As used throughout, “external supply of hydrogen” refers to the addition of hydrogen to the feed to the reactor or to the reactor itself. For example, a reactor in the absence of an external supply of hydrogen means that the feed to the reactor and the reactor are in the absence of added hydrogen, gas (H₂) or liquid, such that no hydrogen (in the form H₂) is a feed or a part of a feed to the reactor.

As used throughout, “external supply of catalyst” refers to the addition of catalyst to the feed to the reactor or the presence of a catalyst in the reactor, such as a fixed bed catalyst in the reactor. For example, a reactor in the absence of an external supply of catalyst means no catalyst has been added to the feed to the reactor and the reactor does not contain a catalyst bed in the reactor.

As used throughout, “supercritical water” refers to water at a temperature at or greater than the critical temperature of water and at a pressure at or greater than the critical pressure of water. The critical temperature of water is 373.946° C. The critical pressure of water is 22.06 megapascals (MPa). It is known in the art that hydrocarbon reactions in supercritical water upgrade heavy oil and crude oil containing sulfur compounds to produce products that have lighter fractions. Supercritical water has unique properties making it suitable for use as a petroleum reaction medium where the reaction objectives can include conversion reactions, desulfurization reactions denitrogenation reactions, and demetallization reactions. Advantageously, at supercritical conditions water acts as both a hydrogen source and a solvent (diluent) in conversion reactions, desulfurization reactions and demetallization reactions and a catalyst is not needed. Hydrogen from the water molecules is transferred to the hydrocarbons through direct transfer or through indirect transfer, such as the water-gas shift reaction. In the water-gas shift reaction, carbon monoxide and water react to produce carbon dioxide and hydrogen. The hydrogen can be transferred to hydrocarbons in desulfurization reactions, demetallization reactions, denitrogenation reactions, and combinations.

As used throughout, “heavy end fraction” refers to the fraction of hydrocarbons that boil at 900 deg F. or greater. To be considered the heavy end fraction a T5% cut point must be greater than 900 deg F. The heavy end fraction can include the asphaltene fraction.

As used throughout, “asphaltene fraction” or “asphaltenes” refers to the toluene insoluble fraction as measured by ASTM D 3279.

As used throughout, “coke” refers to the toluene insoluble material present in petroleum.

As used throughout, “cracking” refers to the breaking of hydrocarbons into smaller ones containing few carbon atoms due to the breaking of carbon-carbon bonds.

As used throughout, “upgrade” means one or all of increasing API gravity, decreasing the amount of heteroatoms, decreasing the amount of asphaltene, decreasing the amount of the atmospheric fraction, increasing the amount of light fractions, decreasing the viscosity, and combinations of the same, in a process outlet stream relative to the process feed stream. One of skill in the art understands that upgrade can have a relative meaning such that a stream can be upgraded in comparison to another stream, but can still contain undesirable components such as heteroatoms.

As used throughout, “conversion reactions” refers to reactions that can upgrade a hydrocarbon stream including cracking, isomerization, oligomerization, dealkylation, dimerization, aromatization, cyclization, desulfurization, denitrogenation, deasphalting, demetallization, and combinations of the same.

The following embodiments, provided with reference to the figures, describe the upgrading process.

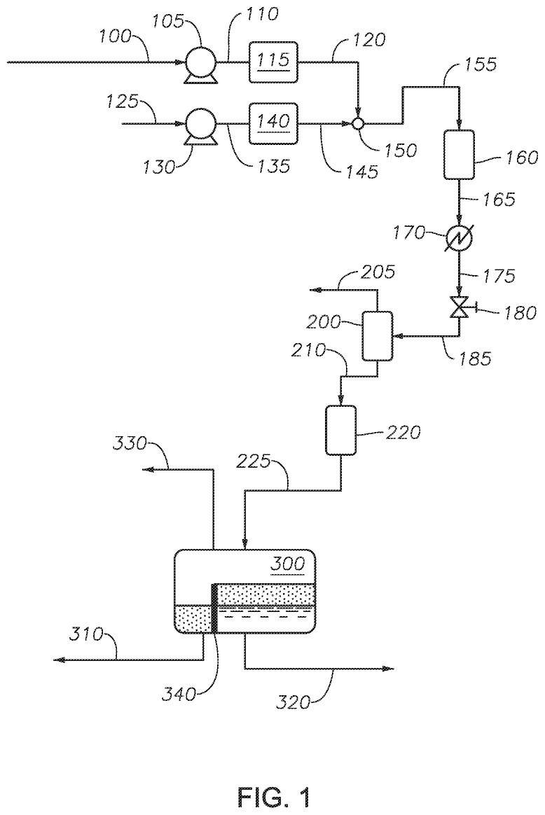

With reference to FIG. 1, an embodiment of the process to separate upgraded oil from water is described. Feed oil 100 is introduced to feed oil pump 105. Feed oil 100 can be any source of single phase oil that has been processed in a desalter and is not live crude oil, but is stabilized, and contains a heavy end fraction. Feed oil 100 can include desalted whole range crude oil, distilled crude oil, residue oil, topped crude oil, product streams from oil refineries, product streams from steam cracking processes, liquefied coals, liquid products recovered from oil or tar sands, bitumen, oil shale, asphaltene, biomass hydrocarbons, liquid product from gas-to-liquid (GTL) processes, and combinations of the same. Feed oil 100 can have an ash content of less than 0.2 weight percent (wt %). Feed oil 100 can have a sodium content of less than 2,000 parts-per-billion weight (ppbw). Feed oil 100 has at least 2 wt % of a heavy end fraction and alternately at least 20 wt % heavy end fraction. Feed oil 100 has at least 0.5 wt % of asphaltene fraction and alternately greater than 0.85 wt % asphaltene fraction.

The pressure of feed oil 100 can be increased in feed oil pump 105 to produce pressurized feed oil 110. Feed oil pump 105 can be any type of high pressure pump configured to increase the pressure of an oil stream. Feed oil pump 105 can be a metering pump. The pressure of pressurized feed oil 110 can be greater than the critical pressure of water, alternately between 22 MPa and 30 MPa, alternately between 23 MPa and 28 MPa, and alternately 23 MPa and 27 MPa. Pressurized feed oil 110 can be introduced to feed oil heater 115.

The temperature of pressurized feed oil 110 can be increased in feed oil heater 115 to produce hot feed oil 120. Feed oil heater 115 can be any type of heater capable of increasing a temperature of an oil stream. Examples of heaters suitable for use as feed oil heater 115 include electric heaters, cross exchangers, and fired heaters. The temperature of hot feed oil 120 can be between ambient temperature and 250 deg C. and alternately between 80 deg C. and 150 deg C. Hot feed oil 120 can be introduced to mixer 150.

Feed water stream 125 can be any source of demineralized water. Feed water stream 125 can have a conductivity less than 1 microSiemens per centimeter (0/cm), alternately less than 0.5 μS/cm, and alternately less than 0.1 μS/cm. Feed water stream 125 can have a sodium content less than 5 micrograms per liter (μg/l) and alternately 1 μg/l. Feed water stream 125 can have a chloride content of less than 5 μg/l and alternately 1 μg/l. Feed water stream 125 can have less a silica content of less than 3 μg/l.

The pressure of feed water stream 125 can be increased in feed water pump 130 to produce pressurized feed water 135. Feed water pump 130 can be any type of high pressure pump configured to increase the pressure of a water stream. Feed water pump 130 can be a metering pump. The pressure of pressurized feed water 135 can be greater than the critical pressure of water, alternately between 22 MPa and 30 MPa, alternately between 23 MPa and 28 MPa, and alternately 23 MPa and 27 MPa. Pressurized feed water 135 can be introduced to feed water heater 140.

The temperature of pressurized feed water 135 can be increased in feed water heater 140 to produce supercritical water stream 145. Feed water heater 140 can be any type of heater capable of increasing a temperature of a water stream. Examples of heaters suitable for use as feed water heater 140 can include electric heaters, cross exchangers, and fired heaters. The temperature of supercritical water stream 145 can be greater than the critical temperature of water, alternately between 374 deg C. and 600 deg C., and alternately between 374 deg C. and 500 deg C. Supercritical water stream 145 can be introduced to mixer 150.

Hot feed oil 120 and supercritical water stream 145 can be mixed in mixer 150 to produce mixed feed stream 155. Mixer 150 can be any type of mixer capable of mixing an oil stream and a water stream. Examples of mixers suitable for use as mixer 150 can include a t-junction and inline mixer. Mixer 150 can include one or more mixers in series. The ratio of the volumetric flow rate of hot feed oil 120 to the volumetric flow rate of supercritical water stream 145 in mixer 150 can be in the range of 10 to 1 and 0.1 to 1 at standard atmospheric temperature and pressure (SATP), alternately in the range between 0.25 to 1 and 2 to 1 at SATP. Mixed feed stream 155 can be introduced to reactor 160.

Reactor 160 can be any type of reactor configured to maintain a reaction at the critical conditions of water. Examples of vessels suitable for use as reactor 160 can include continuous stirred-tank reactors (CSTR), vessel-type reactors, tubular-type reactors or combinations of the same. In at least one embodiment, reactor 160 can include a tubular-type reactor oriented in either as either downflow, upflow, or a combination of both downflow and upflow. Reactor 160 can include multiple reactors in series. The reaction residence time in reactor 160 can be between 0.1 minutes and 60 minutes and alternately between 2 min and 30 min. The reaction residence time in reactor 160 is determined by assuming the density of the internal fluid is that of water at the conditions of the reactor. The temperature of reactor 160 can be greater than the critical temperature of water, alternately between 380 deg C. and 475 deg C., and alternately between 400 deg C. and 450 deg C. The pressure of reactor 160 can be greater than the critical pressure of water, alternately between 23 MPa and 30 MPa, and alternately between 23 MPa and 28 MPa. Reactor 160 can be in the absence of an external supply of catalyst. Reactor 160 can be in the absence of an external supply of hydrogen.

The hydrocarbons in mixed feed stream 155 undergo conversion reactions in reactor 160 to produce upgraded hydrocarbons.

It is known in the art that hydrocarbon reactions in supercritical water upgrade heavy oil and crude oil containing sulfur compounds to produce products that have lighter fractions. Supercritical water has unique properties making it suitable for use as a petroleum reaction medium where the reaction objectives can include conversion reactions, desulfurization reactions denitrogenation reactions, and demetallization reactions. Supercritical water is water at a temperature at or greater than the critical temperature of water and at a pressure at or greater than the critical pressure of water. The critical temperature of water is 373.946° C. The critical pressure of water is 22.06 megapascals (MPa). Advantageously, at supercritical conditions water acts as both a hydrogen source and a solvent (diluent) in conversion reactions, desulfurization reactions and demetallization reactions and a catalyst is not needed. Hydrogen from the water molecules is transferred to the hydrocarbons through direct transfer or through indirect transfer, such as the water-gas shift reaction. In the water-gas shift reaction, carbon monoxide and water react to produce carbon dioxide and hydrogen. The hydrogen can be transferred to hydrocarbons in desulfurization reactions, demetallization reactions, denitrogenation reactions, and combinations of the same. The hydrogen can also reduce the olefin content. The production of an internal supply of hydrogen can reduce coke formation.

Without being bound to a particular theory, it is understood that the basic reaction mechanism of supercritical water mediated petroleum processes is the same as a free radical reaction mechanism. Radical reactions include initiation, propagation, and termination steps. With hydrocarbons, initiation is the most difficult step and conversion in supercritical water can be limited due to the high activation energy required for initiation. Initiation requires the breaking of chemical bonds. The bond energy of carbon-carbon bonds is about 350 kJ/mol, while the bond energy of carbon-hydrogen is about 420 kJ/mol. Due to the chemical bond energies, carbon-carbon bonds and carbon-hydrogen bonds do not break easily at the temperatures in a supercritical water process, 380 deg C. to 450 deg C., without catalyst or radical initiators. In contrast, aliphatic carbon-sulfur bonds have a bond energy of about 250 kJ/mol. The aliphatic carbon-sulfur bond, such as in thiols, sulfide, and disulfides, has a lower bond energy than the aromatic carbon-sulfur bond.

Thermal energy creates radicals through chemical bond breakage. Supercritical water creates a “cage effect” by surrounding the radicals. The radicals surrounded by water molecules cannot react easily with each other, and thus, intermolecular reactions that contribute to coke formation are suppressed. The cage effect suppresses coke formation by limiting inter-radical reactions. Supercritical water, having a low dielectric constant compared to liquid phase water, dissolves hydrocarbons and surrounds radicals to prevent the inter-radical reaction, which is the termination reaction resulting in condensation (dimerization or polymerization). Moreover, the dielectric constant of supercritical water can be tuned by adjusting the temperature and pressure. Because of the barrier set by the supercritical water cage, hydrocarbon radical transfer is more difficult in supercritical water as compared to conventional thermal cracking processes, such as delayed coker, where radicals travel freely without such barriers.

However, the heavier fractions in crude oils, such as the asphaltene fraction, have limited solubility in supercritical water such that the heavier fractions do not dissolve readily in supercritical water. For example, light polyaromatic hydrocarbons (PAHs), such as naphthalene, show preferential dissolution in supercritical water over heavy PAHs, which facilitates the formation of a separate phase of heavy PAHs, such as benzopyrene. Such a separate and concentrated phase of heavy PAHs can lead to the formation of coke or a coke precursor in supercritical water. Pressures greater than 35 MPa may reduce the formation of a separate phase of heavy PAHs, but such high pressures are not economically practical due to the limits of current metallurgies.

The heavy end fraction of feed oil 100 can form a separate dense phase in reactor 160 and undergo conversion reactions in the absence of supercritical water. At least a portion of the products from the conversion reactions of the heavy end fraction can be dissolved in the supercritical water phase.

The fluids in reactor 160 can exit as reactor effluent 165. Reactor effluent 165 can include upgraded hydrocarbons, water, a heavy end fraction, and combinations of the same. Reactor effluent 165 can contain an oil-water mixture, where the upgraded hydrocarbons and heavy end fraction are dispersed in the water. Reactor effluent 165 can contain three phases, an oil-rich phase, containing oil and water, a water-rich phase, containing primarily water, and a heavy end phase containing the heavy end fraction with less than 5 wt % water, where the three phases are mixed together in the oil-water mixture.

The temperature of reactor effluent 165 can be reduced in cooling device 170 to produce cooled effluent 175. Cooling device 170 can be any type of exchanger capable of reducing the temperature of a reactor effluent stream. Examples of cooling device 170 can include a heat exchanger and an air cooler. Cooled effluent 175 can be at a temperature between 50 deg C. and 350 deg C. and alternately between 90 deg C. and 250 deg C. Cooled effluent 175 can be introduced to depressurizing device 180.

The pressure of cooled effluent 175 can be reduced in depressurizing device 180 to produce product effluent 185. Depressurizing device 180 can be any type of device capable of reducing the pressure of an effluent stream. Examples of depressurizing device 180 can include a pressure control valve, back pressure regulator, and a coil. Depressurizing device 180 can include one or more devices in series. In at least one embodiment depressurizing device 180 includes 2 or 3 pressure control valves in series. Product effluent 185 can be at a pressure greater than the steam pressure of water at the temperature of cooled effluent 175, alternately a pressure between 0.02 MPa and 10 MPa, and alternately between 0.02 MPa and 5 MPa. In at least one embodiment, the pressure of product effluent 185 is greater than stream pressure of water at the temperature of cooled effluent 175. Product effluent 185 can be introduced to gas-liquid separator 200.

Gas-liquid separator 200 can be any type of vessel unit capable of separating gases and liquid. Depressurizing device 180 works with gas-liquid separator 200 to maintain a pressure in gas-liquid separator 200 at greater than the steam pressure of water at the temperature in gas-liquid separator 200. The piping line connecting depressurizing device 180 and gas-liquid separator 200 can include additional valves and pipe fittings to maintain the pressure in gas-liquid separator 200 at greater than the steam pressure of water. The piping line containing vapor product 205 and liquid product 210 can include additional valves and pipe fittings to maintain the pressure in gas-liquid separator 200 at greater than the steam pressure of water. The valves and pipe fittings on piping lines connected to gas-liquid separator 200 can operate together to maintain the pressure in gas-liquid separator 200 at greater than the steam pressure of water. Product effluent 185 can be separated in gas-liquid separator to produce vapor product 205 and liquid product 210. Vapor product 205 can contain non-hydrocarbon gases, light hydrocarbon gases, and combinations of the same. Non-hydrocarbon gases can include water vapor, hydrogen sulfide, carbon monoxide, carbon dioxide and combinations of the same. Light hydrocarbon gases can include methane, ethane, ethylene, propane, propylene, butane, butene, pentane, pentene, and combinations of the same. In gas-liquid separator 200 the oil-water mixture can partially resolve itself into an oil-rich phase and a water-rich phase. The oil rich phase can include upgraded hydrocarbons. The water-rich phase can contain the heavy end fraction dispersed throughout the water such that the water-rich phase contains a heavy end fraction. The heavy end fraction can be physically associated with upgraded hydrocarbons.

Liquid product 210 can be introduced to product mixing tank 220. Liquid product 210 contains the water phase, upgraded hydrocarbons, a heavy end fraction, and combinations of the same. Product mixing tank 220 can be any type of vessel capable of applying a shear stress in a liquid, such as by mixing. Product mixing tank 220 can include an internal mixing device, such as an agitator. The mixing residence time of the internal fluid in product mixing tank 220 can be between 5 minutes and 120 minutes and alternately between 10 minutes and 60 minutes. Product mixing tank 220 can include an agitator at a speed between 10 rotations per minute (rpm) and 800 rpm, alternately between 300 rpm and 700 rpm. The temperature in product mixing tank 220 can be in the range between 10 deg C. and 180 deg C., alternately between 90 deg C. and 180 deg C., and alternately between 30 deg C. and 75 deg C. In at least one embodiment, the temperature in product mixing tank 220 is between 30 deg C. and 75 deg C. Maintaining a temperature below 180 deg C. maintains the heavy end fraction separate from the upgraded hydrocarbons and the oil-rich phase. The temperature in product mixing tank 220 can be maintained by an internal or external heating device. Depressurizing device 180, gas-liquid separator 200, and product mixing tank 220 can be designed to maintain a pressure in product mixing tank 220 that is greater than the steam pressure of water at the temperature in mixing tank 220. The piping line connecting gas-liquid separator 200 and product mixing tank 220 can include additional valves and pipe fittings to maintain the pressure in product mixing tank 220 at greater than the steam pressure of water. Mixing liquid product 210 in product mixing tank 220 can produce mixed liquid product 225. Applying a shear stress to the liquid in product mixing tank 220 can cause the upgraded hydrocarbons associated with the heavy end fraction to dissociate and move into the oil-rich phase. Product mixing tank 220 provides additional time and volume to separate the oil-rich phase and the water-rich phase. Additionally, product mixing tank 220 can increase the dispersion of heavy end fraction in the water. Product mixing tank 220 is in the absence of a demulsifying agent. Mixed liquid product 225 can contain upgraded hydrocarbons, water, gases, heavy end fraction, and combinations of the same. Mixed liquid product 225 can contain an oil-rich phase containing primarily upgraded hydrocarbons and a water-rich phase containing water and the heavy end fraction. Mixed liquid product 225 can be evaluated based on the droplet size of the upgraded hydrocarbons in the water-rich phase with increased droplet size resulting in shorter time for separation of oil from water. Mixing can continue until the size of the droplets is greater than 10 microns, alternately greater than 0.1 millimeters (mm), alternately greater than 1 mm, alternately greater than 2 mm, alternately greater than 3 mm, and alternately greater than 5 mm. Mixed liquid product 225 can be introduced to product separation tank 300.

Mixed liquid product 225 can be separated in product separation tank 300 to produce product oil stream 310, spent water 320, and gas product 330. Product separation tank 300 can be in the absence of a demulsifying agent or demulsifier. By not using a demuslfying agent the present processes and systems provide

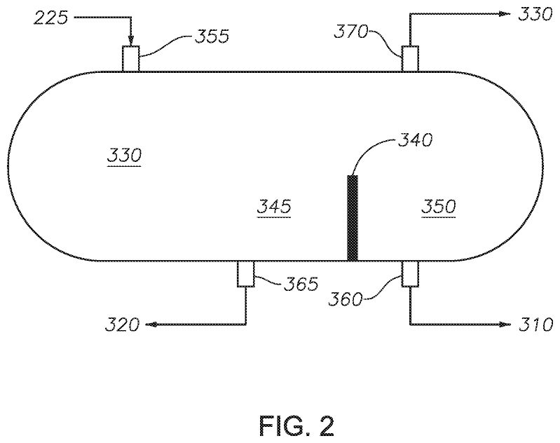

Product separation tank 300 can be any horizontal tank capable of separating two liquid phases over weir 340. Product separation tank 300 can be understood with respect to FIG. 2.

Mixed liquid product 225 enters through inlet 355 located in the top half of product separation tank 300 into inlet section 345. The liquids in mixed liquid product 225 can accumulate in inlet section 345 of product separation tank 300. The liquids in inlet section 345 can separate due to the specific gravity differences of the components. The upgraded hydrocarbons can rise and float on top of a water layer in inlet section 345. Because gravity separation is used, full separation of the heavy end fraction from the water phase is not achieved. Weir 340 can separate inlet section 345 and oil collection section 350. As the liquid level in inlet section 345 rises, the floating layer of upgraded hydrocarbons can spill over weir 340 into oil collection section 350. The phase boundary between the water layer and the floating layer can be measured and can be controlled by a control valve in spent water 320. The control valve can operate to control the location of the phase boundary to position the phase boundary such that the upgraded hydrocarbons in the floating layer are able to spill over weir 340, but without spillover of water from the water layer. The specific location of inlet 355 and weir 340 can be designed based on the process conditions, including flow rates in the process. The separation residence time of the liquids in inlet section 345 is at least 10 minutes, alternately between 10 minutes and 1 hour, and alternately between 10 minutes and 30 minutes. The volume of product separation tank 300 can be designed in consideration of the targeted separation residence time. The separation residence time can be designed to provide adequate settling time to allow separation of the upgraded hydrocarbons from the water layer.

The temperature of product separation tank 300 can be between 50 deg C. and 150 deg C. and alternately between 70 deg C. and 110 deg C. An external or internal heating device can be used to maintain the temperature in product separation tank 300. The pressure in product separation tank 300 is greater than the steam pressure of water at the temperature in product separation tank 300. Maintaining a pressure in product separation tank 300 is important to maintain the water in the liquid phase and minimize the amount of water that evaporates as steam and exits with the light hydrocarbons through vapor outlet 370. Minimizing or eliminating steam generation maintains the phase boundary between the water layer and the floating layer. Steam generation produces bubbles that can rise up through the liquid layers and disrupt the phase boundary making it difficult to measure the location of the phase boundary and as a result control the location of the phase boundary. Vapors present in mixed liquid product 225 can separate due to the operating conditions in product separation tank 300. The separated vapors can exit through vapor outlet 370 as gas product 330.

The upgraded hydrocarbons that collect in oil collection section 350 can exit product separation tank 300 through product outlet 360 as product oil stream 310. Product oil stream 310 can contain upgraded hydrocarbons relative to the hydrocarbons in feed oil 100. Product oil stream 310 can contain less than 1 wt % water and alternately less than 0.3 wt % water. Product oil stream 310 can contain less amount of the heavy end fraction than processes in the absence of the product separation tank. In at least one embodiment, product oil stream 310 is in the absence of a heavy end fraction. By remaining in the water layer in inlet section 345 the heavy end fraction is rejected from the floating layer of upgraded hydrocarbons.

After the separation residence time, the water layer in inlet section 345 can exit through water outlet 365 as spent water 320. Spent water 320 can contains a water phase. The water phase includes water and the heavy end fraction. Spent water 320 can contain between 0.1 wt % and 10 wt % and alternately between 1 wt % and 5 wt %. Spent water 320 can be sent for disposal or can be treated.

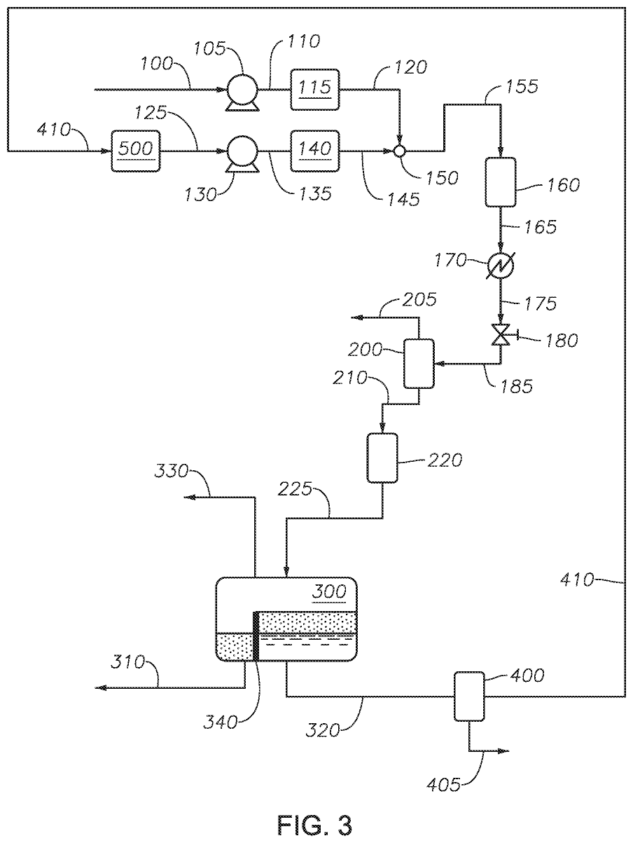

In at least one embodiment, as described with reference to FIG. 3, spent water 310 can be treated in water treatment unit 400. Water treatment unit 400 can be any type of unit or system capable of removing oil from a water stream. Water treatment unit 400 can include an API separator with a sludge sump port and water filters. Water filters in waste treatment unit 400 can include microfilters, reverse osmosis packages, and combinations of the same. Water treatment unit 400 can separate heavy end fraction in spent water 310 to produce sludge 405 and recycled water 410. Sludge 405 can contain the heavy end fraction and water. Sludge 405 can contain between 5 wt % and 25 wt % water, alternately between 10 wt % and 20 wt %, and alternately between 15 wt % and 20 wt %. Sludge 405 can be disposed as waste or can be used for fuel.

Recycled water 410 includes clean water with less than 100 wt ppm total organic content (TOC), alternately less than 10 wt ppm, and alternately less than 5 wt ppm. Recycled water 410 produced in water treatment unit 400 can have the same specifications described with reference to feed water stream 125.

Recycled water 410 can be introduced to water storage tank 500. Water storage tank 500 can be used to store recycled water 410. Water storage tank 500 can be the source of feed water stream 125. A make-up water stream can also be added to water storage tank 500 to maintain the required volumetric flow rate for feed water stream 125 and properties.

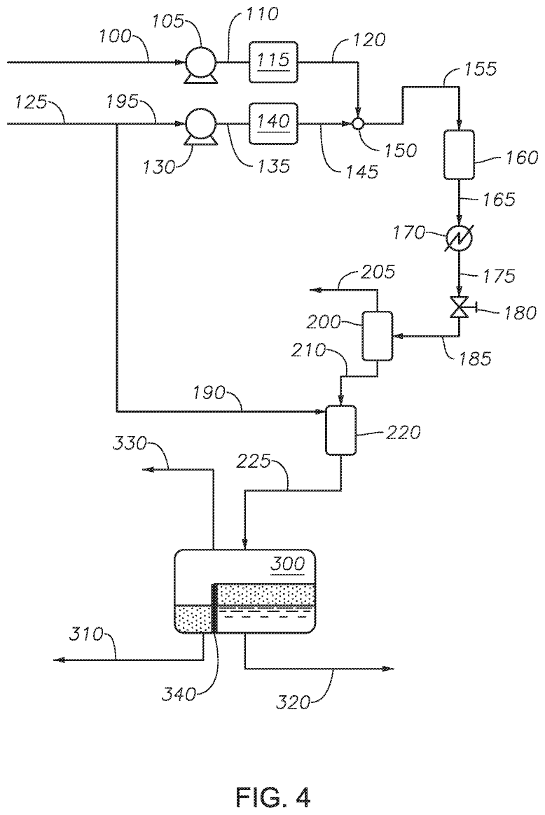

An alternate embodiment of the process is described with reference to FIG. 4 and FIG. 1. A stream can be separated from feed water stream 125 as separated water stream 190. The remaining flow from feed water stream 125 can be introduced to feed water pump 130 as water feed 195.

Separated water stream 190 can be introduced to product mixing tank 220. Adding the water in separated water stream 190 to product mixing tank 220 can enhance separation of water and the upgraded hydrocarbons. Separated water stream 190 is added to product mixing tank 220 when the volumetric ratio of hydrocarbons to water in product mixing tank is greater than 1 at standard atmospheric temperature and pressure. The volumetric flow rate of separated water stream 190 can be adjusted to maintain a volumetric ratio of hydrocarbons to water in product mixing tank 220 of less than 0.8 and alternately less than 0.5. A volumetric ratio of hydrocarbons to water of 0.8 equals a ratio of 1 to 1.25 or 25 vol % more water than hydrocarbons.

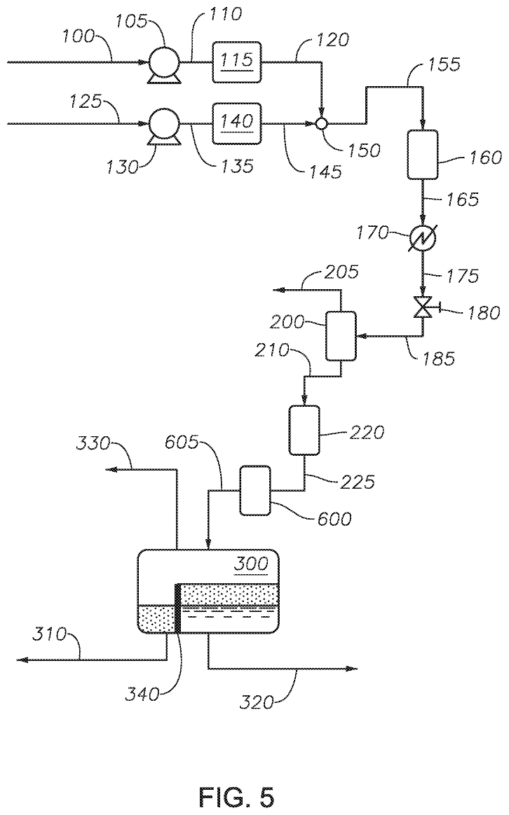

In an alternate embodiment of the process, described with reference to FIG. 5 and FIG. 1, mixed liquid product 225 can be introduced to continuous centrifuge unit 600. Continuous centrifuge unit 600 can be any type of centrifuge machine capable enhancing settling of the heavy end fraction in the water of mixed liquid product 225. Applying a centrifuge from a continuous centrifuge unit can induce flocculation of the heavy end fraction, which can separate and pull heavy end fraction from the oil-rich phase. Continuous centrifuge unit 600 can produce forces of acceleration (g-forces) between 200 g-forces and 1,500 g-forces and alternately between 500 g-forces and 1,000 g-forces. The hold-up volume in continuous centrifuge unit 600 is between 0.05 minutes per volumetric flow rate (volume per minute) and 0.25 minutes per volumetric flow rate. By way of example, for a volumetric flow rate of mixed liquid product 225 of 100 liters/minute, the hold-up volume would be between 5 liters and 25 liters. The entire liquid flow from continuous centrifuge 600 can exit through centrifuge outlet stream 605.

The processes and systems described here are in the absence of an extraction unit that extracts heavy end fraction from an upgraded hydrocarbon fraction. Advantageously, the processes and systems described here can maximize conversion of the heavy end and minimize production of coke, by withdrawing the entire stream from the supercritical water reactor. The separation of the heavy end fraction from the upgraded hydrocarbons occurs at operating conditions below the critical temperature and critical pressure of water, such that the water is subcritical water. The feed oil for processes and systems described here are in the absence of

### Examples

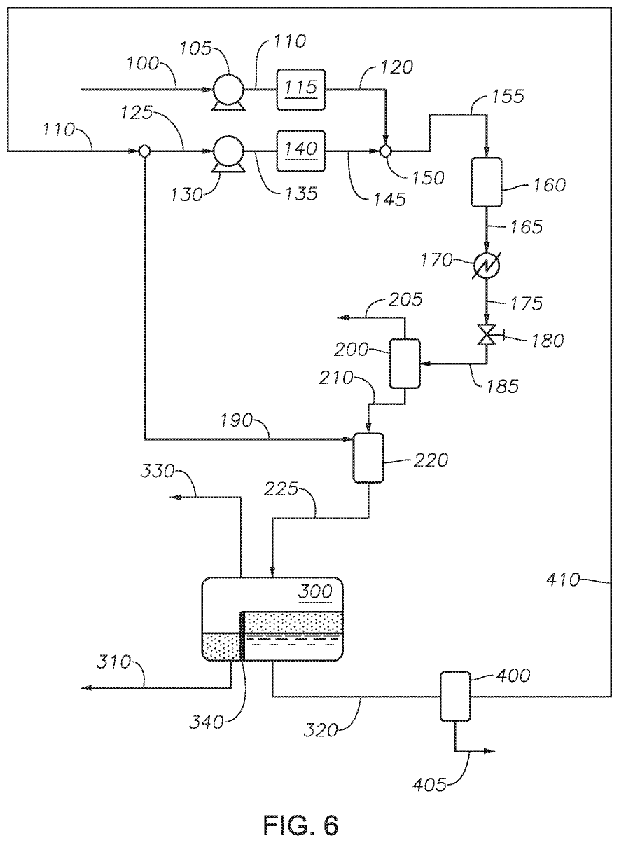

The Example is a simulated analysis of the process according to the process described with reference to FIG. 6. The simulation was prepared using Aspen-HYSYS based on experimental data drawn from experimental runs in a pilot plant. Feed oil 100 was modeled as an Arabian crude oil having the properties shown in Table 1.

TABLE 1
Properties of feed oil 100

| Property | Units | 100 |
|---|---|---|
| API Gravity | API | 12.95 |
| Sulfur | wt % | 3.82 |
| Viscosity @ | cSt | 650 |
| 122 deg F. (50 deg C.) | | |
| Asphaltene Fraction | wt % | 4.9 |
| Vanadium | wt ppm | 90 |
| Nickel | wt ppm | 27 |

True Boiling Point (TBP)

| | | |
|---|---|---|
| 5% | deg C. | 306 |
| 10% | deg C. | 342 |
| 30% | deg C. | 420 |
| 50% | deg C. | 496 |
| 70% | deg C. | 568 |
| 90% | deg C. | 643 |
| 95% | deg C. | 694 |

*cSt = centiStokes
+ wt ppm = parts per million by weight

The stream properties from the simulation are shown in Table 2.

TABLE 2
Stream Properties

| Name | 100 | 125 | 110 | 135 | 120 | 145 | 155 | 165 | 175 |
|---|---|---|---|---|---|---|---|---|---|
| Temperature (C.) | 20 | 25 | — | — | 170 | 480 | 395 | 445 | 210 |
| Pressure (MPa) | 0.17 | 0.17 | 27.00 | 27.00 | 27.00 | 27.00 | 27.00 | 27.00 | 27.00 |
| Mass Flow (kg/h) | 486 | 661 | 486 | 661 | 486 | 661 | 1147 | 1147 | 1147 |
| Liquid Volume Flow | 75.0 | 100.0 | | | | | | | |
| (barrel/day) | | | | | | | | | |

| Name | 185 | 205 | 210 | 225 | 330 | 310 | 320 | 410 | 190 | 405 |
|---|---|---|---|---|---|---|---|---|---|---|
| Temperature (C.) | 120 | 110 | 110 | 50 | 50 | 50 | 50 | 50 | 50 | 50 |
| Pressure (MPa) | 0.21 | 0.21 | 0.21 | 0.18 | 0.18 | 0.18 | 0.18 | 0.18 | 0.18 | 0.18 |
| Mass Flow (kg/h) | 1147 | 32 | 1115 | 1115 | 0.4 | 470 | 645 | 609 | 35 | 21 |
| Liquid Volume Flow | | | | | | 74.3 | 97.5 | 92.2 | 5.4 | |
| (barrel/day) | | | | | | | | | | |

The properties of product oil stream 310 and sludge 405 are shown in Table 3. The properties of sludge 405 were obtained by extracting hydrocarbons with dichloromethane (DCM) from the experimental runs.

TABLE 3
Properties of product oil stream 310 and sludge 405

| Property | Units | 310 | 405 |
|---|---|---|---|
| API Gravity | API | 17.4 | 7.8 |
| Sulfur | wt % | 2.76 | 4.9 |
| Viscosity @ | cSt | 27 | Immeasurable |
| 122 deg F. (50 deg C.) | | | |
| Asphaltene Fraction | wt % | 0.7 | 12 |
| Vanadium | wt ppm | 12 | 125 |
| Nickel | wt ppm | 36 | |

True Boiling Point (TBP)

| | | | |
|---|---|---|---|
| 5% | deg C. | 220 | 516 |
| 10% | deg C. | 283 | 516 |
| 30% | deg C. | 387 | 540 |
| 50% | deg C. | 464 | 575 |
| 70% | deg C. | 524 | 606 |
| 90% | deg C. | 607 | 628 |
| 95% | deg C. | 668 | 634 |

For comparison, a sample of hydrocarbons in the oil-rich phase produced without a product separation tank was obtained during the experimental runs. The properties of the oil-rich phase are shown in Table 4.

TABLE 4
Properties of product oil in the absence of a product
separation tank

| Property | Units | 310 |
|---|---|---|
| API Gravity | API | 16.7 |
| Sulfur | wt % | 2.87 |
| Viscosity @ | cSt | 59 |
| 122 deg F. (50 deg C.) | | |
| Asphaltene Fraction | wt % | 1.3 |
| Vanadium | wt ppm | 18 |
| Nickel | wt ppm | |

True Boiling Point (TBP)

| | | |
|---|---|---|
| 5% | deg C. | 222 |
| 10% | deg C. | 289 |
| 30% | deg C. | 392 |
| 50% | deg C. | 468 |
| 70% | deg C. | 524 |
| 90% | deg C. | 618 |
| 95% | deg C. | 677 |

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

There various elements described can be used in combination with all other elements described here unless otherwise indicated.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed here as from about one particular value to about another particular value and are inclusive unless otherwise indicated. When such a range is expressed, it is to be understood that another embodiment is from the one particular value to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these references contradict the statements made here.

As used here and in the appended claims, the words “comprise,” “has,” and “include” and all grammatical variations thereof are each intended to have an open, non-limiting meaning that does not exclude additional elements or steps.

1. A method of producing a product oil stream, the method comprising the steps of:
introducing a liquid product to a product mixing tank, where the product mixing tank comprises an internal mixing device, where the pressure in the product mixing tank is greater than the steam pressure of water at the temperature of the liquid product;
mixing the liquid product in the product mixing tank for a mixing residence time to produce a mixed liquid product, where the mixing residence time is between 5 minutes and 120 minutes;
introducing the mixed liquid product to a product separation tank, where the product separation tank comprises a weir, where the pressure in the product mixing tank is greater than the steam pressure of water at the temperature of the liquid product;
maintaining the mixed liquid product in the product separation tank for a separation residence time, where the separation residence time is at least 10 minutes;
separating upgraded hydrocarbons from the mixed liquid product in the product separation tank, here the separation of upgraded hydrocarbons from the mixed liquid product occurs due to gravity separation where the separation residence time allows the upgraded hydrocarbons to separate from and float on top of a water layer in an inlet section of the product separation tank;
operating the product separation tank such that the upgraded hydrocarbons flow over a weir, the weir configured to separate the inlet section from an oil collection section, where the upgraded hydrocarbons collect in the oil collection section;
withdrawing the product oil stream from the oil collection section, where the product oil stream comprises upgraded hydrocarbons; and
withdrawing a spent water from the inlet section of the product separation tank, where the spent water comprises water and a heavy end fraction.

2. The method of claim 1, further comprising the step of withdrawing a gas product from the product separation tank.

3. The method of claim 1, further comprising the steps of:
introducing the spent water to a water treatment unit, the water treatment unit configured to separate the heavy end fraction from the water; and
separating the heavy end fraction from the water in the water treatment unit to produce a recycled water and a sludge, where the recycled water stream comprises clean water, where the sludge comprises the heavy end fraction.

4. The method of claim 3, further comprising the step of introducing the recycle water to a water storage tank.

5. The method of claim 1, further comprising the steps of:
introducing a feed oil to a feed oil pump, where the feed oil comprises a single phase oil processed in a deasalter, where the feed oil comprises a heavy end fraction, where the amount of the heavy end fraction is at least 2 wt %;
increasing a pressure of the feed oil in the feed oil pump to produce a pressurized feed oil, where the pressure of the pressurized feed is greater than the critical pressure of water;
introducing the pressurized feed oil to a feed oil heater;
increasing a temperature of the pressurized feed oil in the feed oil heater to produce a hot feed oil, where a temperature of the hot feed oil is between ambient temperature and 250 deg C.;
introducing the hot feed oil to a mixer;
introducing a feed water stream to a feed water pump, where the feed water stream comprises a demineralized water;
increasing a pressure of the feed water stream in the feed water pump to produce a pressurized feed water, where the pressure of pressurized feed water is greater than the critical pressure of water;
introducing the pressurized feed water to a feed water heater;
increasing a temperature of the pressurized feed water in the feed water heater to produce a supercritical water stream, where the temperature of the supercritical water stream is greater than the critical temperature of water;
introducing the supercritical water stream to the mixer;
mixing the hot feed oil and the supercritical water stream in the mixer to produce a mixed feed stream;
introducing the mixed feed stream to a reactor;
reacting the mixed feed stream in the reactor to produce a reactor effluent, where mixed feed stream undergoes conversion reactions, where the reactor effluent comprises upgraded hydrocarbons, and a water phase;
introducing the reactor effluent to a cooling device;
reducing a temperature of the reactor effluent in the cooling device to produce a cooled effluent, where the temperature of the cooled effluent is between 50 deg C. and 350 deg C.;
introducing the cooled effluent to a depressurizing device;
reducing a pressure in the depressurizing device to produce a product effluent, where the pressure of the product effluent is greater than the steam pressure of water at the temperature of cooled effluent;
introducing the product effluent to a gas-liquid separator; and
separating the product effluent in the gas-liquid separator to produce a vapor product and the liquid product.

6. The method of claim 1, further comprising the steps of:
introducing a separated water stream to the product mixing tank, where the volumetric flow rate of separated water stream is operable to maintain a volumetric ratio of hydrocarbon to water in product mixing tank of less than 0.8; and
mixing the separated water stream with the liquid product.

7. The method of claim 1, further comprising the steps of:
introducing the mixed liquid product to a continuous centrifuge unit;
centrifuging the mixed liquid product in the continuous centrifuge unit; and
withdrawing a centrifuge outlet stream.

8. The method of claim 1, where the product separation tank is in the absence of a demulsifying agent.

9. A system for producing a product oil stream, the system comprising:
a product mixing tank, the product mixing tank configured to mix a liquid product for a mixing residence time to produce a mixed liquid product, where the mixing residence time is between 5 minutes and 120 minutes, where the product mixing tank comprises an internal mixing device, where the pressure in the product mixing tank is greater than the steam pressure of water at the temperature of the liquid product, where the liquid product comprises upgraded hydrocarbons and a water phase; and
a product separation tank fluidly connected to the product mixing tank, where the pressure in the product mixing tank is greater than the steam pressure of water at the temperature of the liquid product, where the product separation tank is configured to separate upgraded hydrocarbons from the mixed liquid product for a separation residence time, where the separation residence time is at least 10 minutes, where the separation of upgraded hydrocarbons from the mixed liquid product occurs due to gravity separation, where the separation residence time allows the upgraded hydrocarbons to separate from and float on top of a water layer in an inlet section of the product separation tank, where the product separation tank comprises:
an inlet section, the inlet section configured to receive the mixed liquid product, where the gravity separation occurs in the inlet section,
an oil collection section, the oil collection section configured to collect the upgraded hydrocarbons,
a weir, the weir physically separates the inlet section and the oil collection section, where the upgraded hydrocarbons flow over the weir from the inlet section to the oil collection section, and
a product outlet fluidly connected to the oil collection section, where a product oil stream flows from the oil collection section through the product outlet, where the product oil stream comprises upgraded hydrocarbons.

10. The system of claim 9, further comprises a water outlet fluidly connected to the inlet section, where a spent water flows from the inlet section through the water outlet, where the spent water comprises a water phase, where the water phase comprises heavy end fraction dispersed in water.

11. The system of claim 9, further comprising:
a water treatment unit, the water treatment unit configured to separate the heavy end fraction from the water in the spent water, where the heavy end fraction exists the water treatment unit as a sludge, where the water exits the water treatment unit as a recycled water.

12. The system of claim 11, further comprising a water storage tank, the water storage tank configured to collect the recycle water.

13. The system of claim 9, further comprising:
a feed oil pump, the feed oil pump configured to increase a pressure of a feed oil to produce a pressurized feed oil, where the feed oil comprises a single phase oil processed in a deasalter, where the feed oil comprises a heavy end fraction, where the amount of the heavy end fraction is at least 2 wt %, where the pressure of the pressurized feed is greater than the critical pressure of water;
a feed oil heater fluidly connected to the feed oil pump, the feed oil heater configured to increase a temperature of the pressurized feed oil in the feed oil heater to produce a hot feed oil, where a temperature of the hot feed oil is between ambient temperature and 250 deg C.;
a feed water pump, the feed water pump configured to increase a pressure of the feed water stream to produce a pressurized feed water, where the feed water stream comprises a demineralized water, where the pressure of pressurized feed water is greater than the critical pressure of water;
a feed water heater fluidly connected to the feed water pump, the feed water heater configured to increase a temperature of the pressurized feed water to produce a supercritical water stream, where the temperature of the supercritical water stream is greater than the critical temperature of water;
a mixer fluidly connected to the feed oil heater and the feed water heater, the mixer configured to mix the hot feed oil and the supercritical water stream to produce a mixed feed stream;
a reactor fluidly connected to the mixer, where the reactor is configured to react the mixed feed stream in the reactor to produce a reactor effluent, where mixed feed stream undergoes conversion reactions, where the reactor effluent comprises upgraded hydrocarbons and a water phase;
a cooling device fluidly connected to the reactor, the cooling device configured to reduce a temperature of the reactor effluent in the cooling device to produce a cooled effluent, where the temperature of the cooled effluent is between 50 deg C. and 350 deg C.;
a depressurizing device fluidly connected to the cooling device, the depressurizing device configured to reduce a pressure of the cooled effluent to produce a product effluent, where the pressure of the product effluent is greater than the steam pressure of water at the temperature of cooled effluent; and
a gas-liquid separator fluidly connected to the depressurizing device, the gas-liquid separator configured to separate the product effluent to produce a vapor product and the liquid product.

14. The system of claim 9, further comprising:
a continuous centrifuge unit fluidly connected to the product mixing tank, the continuous centrifuge configured to centrifuge the mixed liquid product to produce a centrifuge outlet.

15. The system of claim 14, where the product separation tank is in the absence of a demulsifying agent.
